(19) United States
(12) Patent Application Publication
(10) Pub. No.: US 2012/0079058 A1
(43) Pub. Date: Mar. 29, 2012

(54) CONTEXTUALLY RELEVANT MEDIA BUNDLE

(75) Inventors: Frank R. Bentley, Palatine, IL (US); Sujoy Kumar Chowdhury, St. Joseph, MO (US)

(73) Assignee: MOTOROLA-MOBILITY, INC., Libertyville, IL (US)

(21) Appl. No.: 12/890,833

(22) Filed: Sep. 27, 2010

(51) Int. Cl. G06F 15/16

(52) U.S. Cl. 709/217

(57) ABSTRACT

Disclosed are methods for associating contextual information with a “media bundle.” A user is alerted to the existence of the media bundle when his current context corresponds in a pre-defined way to the context associated with the bundle. Upon being alerted, the user can choose to download and review the contents of the media bundle. In general, the contextual information personalizes the context to an individual or set of individuals and ties the bundle to a matter of particular interest to the individual. In some embodiments, “context triggers” are downloaded to a user's personal device. Each of these triggers specifies the context of a particular media bundle. The user device monitors its current context and alerts the user when the user's current context corresponds to that of one of the context triggers. Some embodiments allow the user, after reviewing the media bundle, to create and upload a response.

### FIELD OF THE INVENTION

The present invention is related generally to digital media and, more particularly, to user-customized digital media.

### BACKGROUND OF THE INVENTION

Family history is an important part of family and personal identity. Parents and relatives often spend time talking to their children about places and events that were important in their lives. These stories serve to bring generations together and create a sense of shared context that is important to “being” family.

However, today these types of rich interactions with family members are limited to the explicit times that the family gathers across generations. Once children leave home, these are often only brief interactions at holidays, at special occasions, or when talking on the telephone.

By the time a young person becomes old enough to take an interest in his ancestry, some of his most recent ancestors may have died, their stories often dying along with them. Scrapbooks of photographs and other memorabilia are very helpful in linking a person to his ancestors and in giving him a feel for their environment. However, these items are often difficult for a young person to put into context: Yes, I recognize my uncle in that picture (though he looks younger than 1 remember him), but who are those people with him? When and where was this photograph taken? And why is my uncle carrying a sledgehammer? Unless the photograph is accompanied by extensive notes or a person in the photograph is still around to answer these questions, the context is lost, rendering the photograph much less informative than it would otherwise be.

### BRIEF SUMMARY

The above considerations, and others, are addressed by the present invention, which can be understood by referring to the specification, drawings, and claims. According to aspects of the present invention, contextual information is associated with a “media bundle.” (A media bundle is an associated set of one or more media presentations. This concept is discussed more thoroughly below.) A user is alerted to the existence of the media bundle when his current context corresponds in a pre-defined way to the context associated with the bundle. Upon being alerted, the user can choose to download and review the contents of the media bundle.

In general, the contextual information personalizes the context to an individual or set of individuals and ties the bundle to a matter of particular interest to the individual. For example, consider a media bundle that includes photographs and a sound recording of a young man's personal memories of the fall of the Berlin Wall on Nov. 9, 1989. The context associated with this bundle may identify the family and friends of that young man, and the context may include the location of the city of Berlin. In this case, only the identified family members and friends would be alerted to the existence of this bundle, and they would only be alerted when they are in Berlin.

Different contextual information can be associated with different media bundles. Other types of contextual information can include the age of the user, presence information associated with people other than the user (for example, the alert is given only when all of the members of a defined group of people are gathered at a location), and an action that must be performed by the user before the alert will be given.

In some embodiments, “context triggers” are downloaded to a user's personal device (e.g., a cellular telephone). Each of these triggers specifies the context of a particular media bundle. The user device monitors its current context and alerts the user when the user's current context corresponds to that of one of the context triggers. Then the user can request that the media bundle be downloaded from a server. In some embodiments, the user is prevented from downloading the bundle until his context matches that of the trigger. However, in some embodiments, a “hint” can be downloaded that tells the user of the existence of a bundle and how he can satisfy its contextual trigger (e.g., by going to a certain location).

Some embodiments allow the user, after reviewing the media bundle, to create and upload a response. For example, the user can record his thoughts on hearing his uncle's story of the fall of the Berlin Wall and can take a picture of himself at the site of the former Wall. The response can include its own contextual information and can become part of the original media bundle.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1; and

FIGS. 3a and 3b together form a flowchart of a method for alerting a user to the existence of a contextually relevant media bundle.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Context-based services have been experimented with for as long as computation has been available to take out into the world. Location-based services that notify users when they are near particular locations are well known in the art, and proximity notifications are a part of modern mobile operating systems. Aspects of the present invention add to this known art by delivering media presentations with rich, personalized context, thus providing opportunities for people to share family stories and to contextualize them in the real world.

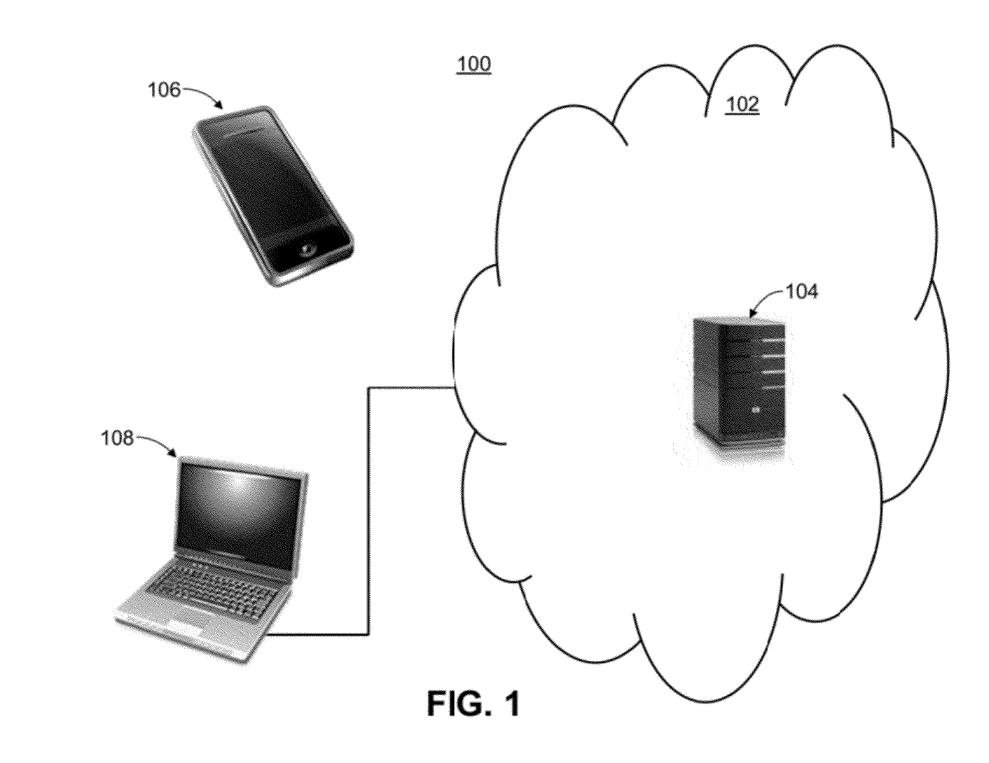

Aspects of the present invention may be practiced in the representative communications environment 100 of FIG. 1. Accessible via a shared network 102, such as the Internet, are various media servers 104 (for clarity's sake, only one server 104 is shown). The servers 104 store “media bundles” and associated contextual information. A “media bundle” is a related set of media presentations, where “media presentations” generally include just about any kind of digital content, and, more specifically, text, sound, video, and interactive files. For example, a media bundle can contain photographs, videos, and recorded reminiscences of an event important to the members of a family. The servers 104 also store contextual information associated with each media bundle and, when appropriate, provide this contextual information along with the media bundle to personal communications devices such as a mobile telephone 106 and a personal computer 108.

The user devices 106, 108 access the servers 104 via any or all of the various known networking technologies. These user devices 106, 108 are used to create media bundles, to associate contextual information with them, to review contextually relevant media bundles, and to create responses to media bundles.

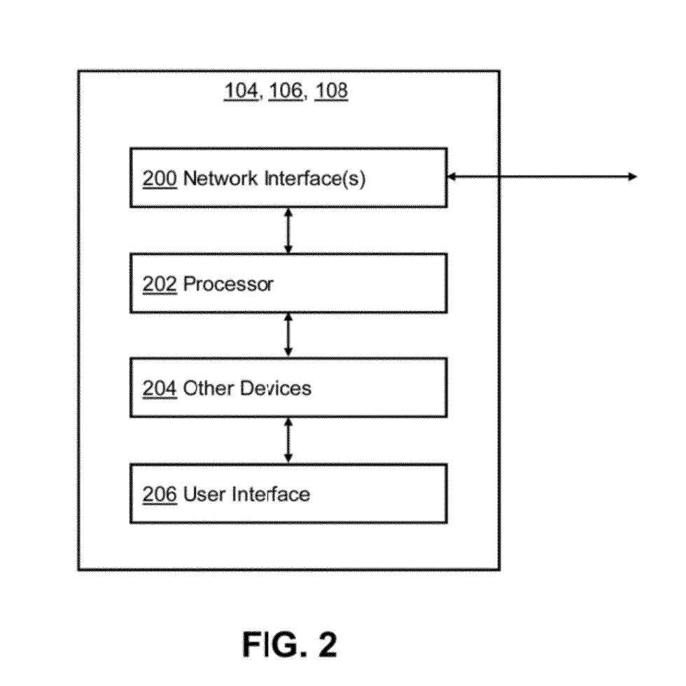

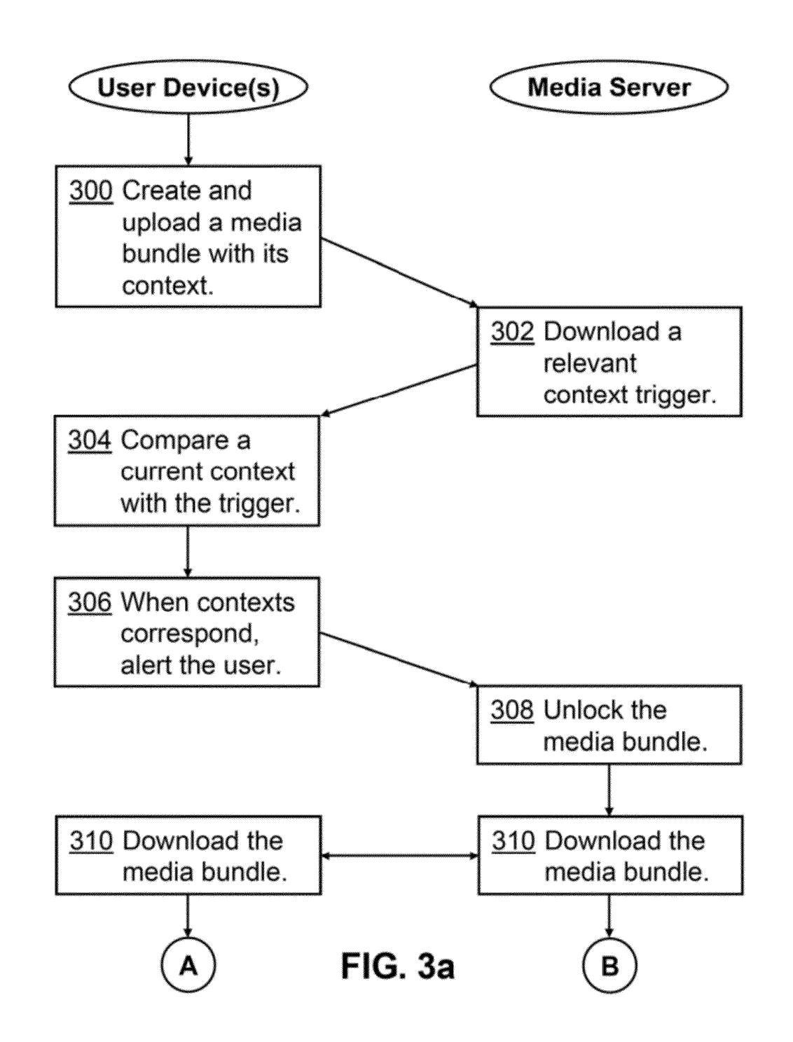

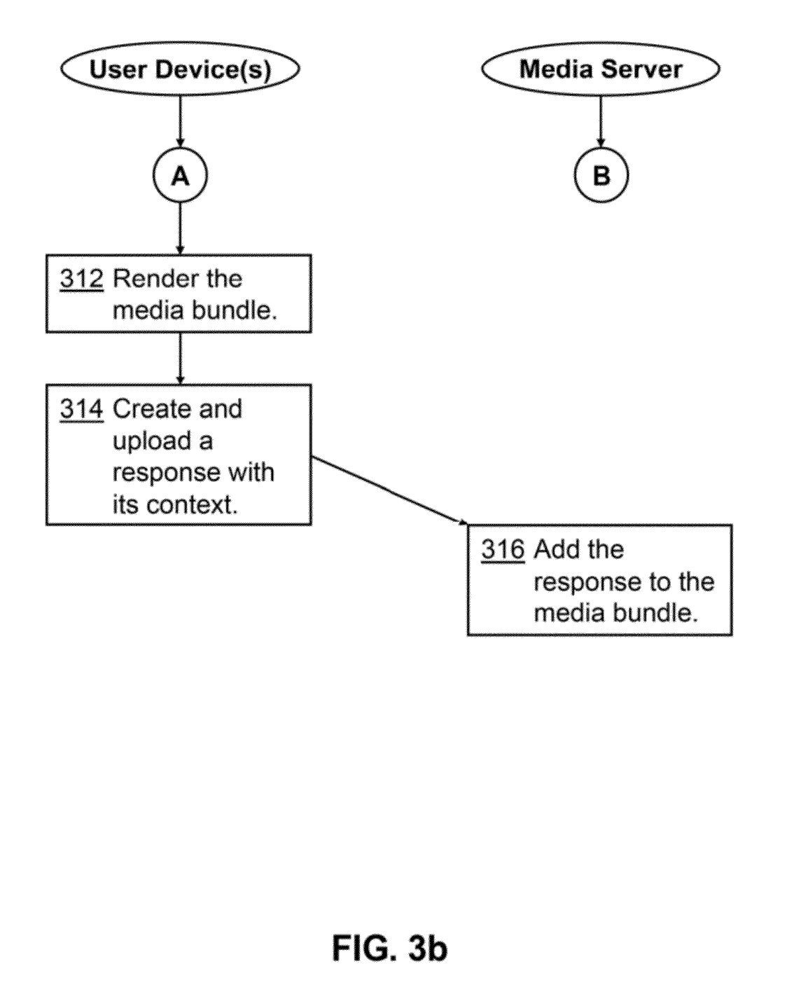

FIG. 2 shows the major components of a representative server 104 or user device 106, 108. Network interfaces 200 send and receive alerts and media presentations, contextual information, and download requests. A processor 202 controls the operations of the device 104, 106, 108 and, in particular, supports aspects of the present invention as illustrated in FIG. 3, discussed below. The “other devices” 204 are known hardware and software elements such as a camera to record a response to a media presentation or a GPS receiver to determine the current location of the user device 106. The user interface 206 supports a user's (or administrator's) interactions with the device. Specific uses of these components by specific devices are discussed as appropriate below.

FIGS. 3a and 3b present a method for creating and viewing a media bundle that has context information associated with it. In step 300 of FIG. 3a, a media bundle is created. Although step 300 is put under the User Device(s) column in FIG. 3a, the creation can occur just about anywhere or at anytime using any kind of device or software. For example, an old photograph can be digitized, or a verbal reminiscence can be recorded. Any of the well known authoring techniques can be applied here. Contextual information is associated with the media bundle. For example, the context can include a list of people authorized to view the bundle or a geographical location relevant to the story told by the contents of the bundle. Some other possible contextual elements are described below in relation to steps 302 through 306. The contextual elements may be chosen by the author or, in some embodiments, automatically added by the authoring tool.

Some embodiments provide an authorizing tool customized for the requirements of the present invention. This “story creation client” can be a web, desktop, or mobile application that provides the means to create a story in the system. For example, the user navigates a map to find the place where the story occurred. After selecting this place and naming the story, he records video, audio, or text and uploads photographs, news articles, and other rich media about that location as a part of telling the story of the importance of that place in his life. He can associate a particular time period with the story.

After authoring, the media presentations and associated contextual information are uploaded to a media server 104. The presentations are linked together to form a coherent media bundle (either at the user device 106 before upload or at the server 104 after upload).

Some time later, in step 302, the server 104 downloads a “context trigger” for a particular media bundle to a user device 106. (Note that this user device 106 need not be the same one used when authoring the media bundle in step 300.) The trigger specifies what contextual constraints the user of the device 106 must satisfy in order to “unlock” this particular media bundle. These constraints are based on the contextual information that was associated with the media bundle when that bundle was authored in step 300. For example, the media bundle should only be given to a specified set of people, so the user must be in that set in order to unlock the bundle.

(In this and other cases, the server 104 can filter through its set of context triggers and only download to a particular user device 106 those triggers that may be relevant to it. If the registered user of the device 106 is not in the set of people specified in the context of this media bundle, than the trigger need not be downloaded to that device 106. Also, if a geographic location of Sweden is among the contextual elements, then the server 104 need not download this particular trigger until it knows that the device 106 is in Sweden.)

Another contextual element expected to be commonly used is geographic location. This location is the location where the story described by the bundle occurred, not necessarily where the bundle was authored. This element can make the bundle more intriguing as the bundle is only unlocked when the user visits the physical setting of the story.

Many other types of contextual information are contemplated. As one example, the story can be tied to the age of a participant in the story at the time the story took place. Then, the story is only unlocked when the user is of a similar age, making the story particularly relevant. Some stories can only be unlocked when a number of people are simultaneously present (based on well known techniques for determining presence). As a final example of a contextual element, a story may be locked until the user performs a particular action. This can be used to force the user to view stories in a particular order.

In step 302, the server 104 can also download a “hint” pointing to the existence of a media bundle that may be of interest to the user of the device 106. For example, the hint can say that his family recorded a story concerning the Biograph Theater in Chicago. The user is told that, in order to unlock the story, he must visit the Biograph (along with satisfying whatever other contextual elements are associated with the media bundle). In some embodiments, a user can query the server 104 for a list of stories which, based on their contextual information, may be relevant to him.

In step 304, the user device 106 repeatedly compares its current context to that of a trigger downloaded to it. For example, the device 106 can periodically compare its location to a location specified in a context trigger. The user device 106 can use well known techniques to save on power by, for example, only checking for a more detailed location when a cell tower changes or when an accelerometer is activated. When a user identity is part of the context trigger, some embodiments always assume that the current user is one registered for this particular device 106. Otherwise, the device 106 can force the user to identify himself, using any well known technique. The user device 106 uses other techniques to monitor other elements of its current context. If, for example, a context trigger requires that a user has already viewed another media bundle, then the server 104 can tell the user device 106 whether this requirement has been met. (More likely, the server 104 will only download this particular trigger once that criterion has been satisfied.)

In any case, when the current context of the user device 106 satisfies all of the contextual criteria of a context trigger, the user device 106 alerts the user of the existence of the media bundle in step 306. Many techniques are known whereby an alert is given to a user via the user interface 206 of the user device 106. For example, a widget can run in a graphical user interface, displaying an icon on a display screen of the device 106. When the user device 106 is a cellular telephone, the device 106 can be made to vibrate or ring as if a call were coming in. Other user interface implementations may provide other user-alert mechanisms such as lights or color changes.

(Note that in some embodiments, the user does not even know of the existence of the media bundle until alerted to it in step 306. As mentioned above, in other embodiments, the user is given a “hint” about the existence of a media bundle.)

Once the context trigger is satisfied for this particular user, the media bundle associated with the trigger is “unlocked” by the server 104 in step 308. The purpose of locking the bundle in the first place is to force the user to satisfy the contextual elements associated with the bundle, thus making the bundle more relevant to the user when he finally views it. Generally, once unlocked, the media bundle remains unlocked for this particular user so that he can always go back and review it.

Now that the media bundle is unlocked, the user can, in step 310, choose to download some or all of the media bundle to his device 106. (In some embodiments, the user device 106 may automatically, and without the user's knowledge, begin downloading some content even before the trigger is satisfied. The content is not shown to the user until the trigger is satisfied. This technique allows the content to be delivered more quickly once requested and allows immediate viewing even in cases where there is no data connection at the time that the trigger is satisfied.) The download need not be requested immediately, and the user may choose to download later when he has more time or is in a quieter environment. He may even choose to download to a device different from the one that alerted him. For example, he may be alerted by his cellular telephone 106 but may choose to view the media bundle on his personal computer 108 because it has a larger screen and better speakers.

In step 312 of FIG. 3b, the user may choose to render some or all of the downloaded media content to his user device 106, 108.

Having viewed the media bundle, the user may choose to respond in step 314. He can simply post an e-mail or call the bundle's author. More interestingly, he can produce his own content and add it to the bundle. To do this, he uses any well known authoring tool (as discussed above in relation to step 300 of FIG. 3a), possibly recording his thoughts on viewing the bundle or telling a family story that is in some manner related to the story he just viewed. He can add contextual elements to his production, just as were added to the original bundle, and then upload the media and the context to the media server 104. The new content can be added to the existing bundle by the server 104 in step 316 or can become a new bundle. In this manner, the media bundles expand into a rich conversation among the member of the family.

Thus, embodiments of the present invention create a strong sense of family and remind people of their relatives and the rich histories of their lives as they pursue their own lives in the world. The contextually relevant media bundles represent a new way to communicate, asynchronous yet media rich, something most people, especially older generations, are quite unfamiliar with. In this way communication becomes contextualized instead of time-bound, and viewing can occur months or even years after the disclosure to the system.

In view of the many possible embodiments to which the principles of the present invention may be applied, it should be recognized that the embodiments described herein with respect to the drawing figures are meant to be illustrative only and should not be taken as limiting the scope of the invention. For example, various steps of FIGS. 3a and 3b can be optional, performed in a different order, or performed on devices different from those illustrated. Therefore, the invention as described herein contemplates all such embodiments as may come within the scope of the following claims and equivalents thereof.

We claim:

1. A method for alerting a user of a user device to an existence of a contextually relevant media bundle, the method comprising:
receiving, by the user device, a context trigger;
monitoring, by the user device, a current context of the user device, wherein the current context comprises an identity of the user of the user device and at least one other element; and
when the current context of the user device corresponds to a context associated with the context trigger, alerting the user of the user device to the existence of the contextually relevant media bundle;
wherein the user of the user device is prevented from accessing the contextually relevant media bundle until the current context of the user device corresponds to the context associated with the context trigger.

2. The method of claim 1 wherein the user device is selected from the group consisting of: a mobile telephone and a personal computer.

3. The method of claim 1 wherein the current context of the user device comprises an element selected from the group consisting of: a location of the user device, an age of the user of the user device, presence information associated with at least one person other than the user of the user device, and an action performed by the user of the user device.

4. The method of claim 1 further comprising:
when the current context of the user device corresponds to a context defined by the context trigger, unlocking for the user of the user device the contextually relevant media bundle.

5. The method of claim 1 further comprising:
when the current context of the user device corresponds to a context defined by the context trigger, requesting, by the user device, a download of the contextually relevant media bundle.

6. The method of claim 5 further comprising:
rendering, by the user device to the user of the user device, at least a portion of the contextually relevant media bundle.

7. The method of claim 6 further comprising:
creating, by the user of the user device, a response to the contextually relevant media bundle;
associating, by the user device, a context with the response, wherein the associated context comprises an identity of the user of the user device; and
uploading, by the user device, the response.

8. A user device for alerting a user of the user device to an existence of a contextually relevant media bundle, the user device comprising:
a communications interface configured for receiving a context trigger;
a user interface; and
a processor operatively connected to the communications interface and to the user interface, the processor configured for:
monitoring a current context of the user device, wherein the current context comprises an identity of the user of the user device and at least one other element; and
when the current context of the user device corresponds to a context associated with the context trigger, alerting, via the user interface, the user of the user device to the existence of the contextually relevant media bundle;
wherein the user of the user device is prevented from accessing the contextually relevant media bundle until the current context of the user device corresponds to the context associated with the context trigger.

9. The user device of claim 8 wherein the user device is selected from the group consisting of: a mobile telephone and a personal computer.

10. The user device of claim 8 wherein the current context of the user device comprises an element selected from the group consisting of: a location of the user device, an age of the user of the user device, presence information associated with at least one person other than the user of the user device, and an action performed by the user of the user device.

11. The user device of claim 8 wherein the processor is further configured for:
when the current context of the user device corresponds to a context defined by the context trigger, unlocking for the user of the user device the contextually relevant media bundle.

12. The user device of claim 8 wherein the processor is further configured for:
when the current context of the user device corresponds to a context defined by the context trigger, requesting, via the communications interface, a download of the contextually relevant media bundle.

13. The user device of claim 12 wherein the processor is further configured for:
rendering, via the user interface, at least a portion of the contextually relevant media bundle.

14. The user device of claim 13 wherein the processor is further configured for:
creating, via the user interface, a response to the contextually relevant media bundle;
associating a context with the response, wherein the associated context comprises an identity of the user of the user device; and
uploading, via the communications interface, the response.

15. A method for creating a contextually relevant response to a contextually relevant media bundle, the method comprising:
rendering, by a first user device to a user of the first user device, at least a portion of the contextually relevant media bundle;
creating, by the user of the first user device, a response to the contextually relevant media bundle;
associating, by the first user device, a context with the response, wherein the associated context comprises an identity of the user of the first user device and at least one other element; and
uploading, by the first user device, the response;
wherein access by a second user device to the response is prevented until a current context of the second user device corresponds to the context associated with the response.

16. The method of claim 15 wherein the associated context comprises an element selected from the group consisting of: a location of the first user device, an age of the user of the first user device, and presence information associated with at least one person other than the user of the first user device.

17. A first user device for creating a response to a contextually relevant media bundle, the user device comprising:
a communications interface;
a user interface configured for rendering at least a portion of the contextually relevant media bundle; and
a processor operatively connected to the communications interface and to the user interface, the processor configured for:
creating, via the user interface, a response to the contextually relevant media bundle;
associating a context with the response, wherein the associated context comprises an identity of the user of the first user device and at least one other element; and
uploading, via the communications interface, the response;
wherein access by a second user device to the response is prevented until a current context of the second user device corresponds to the context associated with the response.

18. A method for a server to distribute a contextually relevant media bundle, the method comprising:
sending, by the server to a user device, a context trigger;
receiving, by the server from the user device, a request to download the contextually relevant media bundle associated with the context trigger; and
downloading, by the server to the user device, the contextually relevant media bundle.

19. The method of claim 18 wherein sending a context trigger comprises filtering, by the server, a list of context triggers to find a context trigger whose associated context corresponds to a current context of the user device.

20. A server for distributing a contextually relevant media bundle, the server comprising:
a communications interface configured for sending, to a user device, a context trigger and for receiving, from the user device, a request to download the contextually relevant media bundle associated with the context trigger; and
a processor operatively connected to the communications interface, the processor configured for:
downloading, via the communications interface to the user device, the contextually relevant media bundle.

21. The server of claim 20 wherein sending a context trigger comprises filtering a list of context triggers to find a context trigger whose associated context corresponds to a current context of the user device.
